(19) United States
(12) Patent Application Publication
(10) Pub. No.: US 2006/0210771 A1
(43) Pub. Date: Sep. 21, 2006

(54) Cleaning sheet with improved three-dimensional cleaning surface

(76) Inventor: James Schaeffer, Charleston, SC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/439,573

(22) Filed: May 23, 2006

Related U.S. Application Data
(63) Continuation of application No. 10/913,624, filed on Aug. 6, 2004, now abandoned.
(60) Provisional application No. 60/493,123, filed on Aug. 7, 2003.

(51) Int. Cl. B32B 3/00

(52) U.S. Cl. 428/156; 442/327

(57) ABSTRACT

The present invention is directed to a nonwoven fabric, and specifically to an engineered nonwoven fabric imparted with a discontinuous, irregular, three-dimensional pattern, which results in a sufficiently resilient material that exhibits a uniform multi-directional cleaning performance imminently suitable for numerous applications including the treatment, cleaning and/or cleansing of surfaces.

### CROSS-REFERENCE TO RELATED APPLICATION

This application is a continuation of U.S. Ser. No. 10/913,624 filed Aug. 6, 2004, which claims the benefit of priority Provisional Application No. 60/493,123, filed Aug. 7, 2003, the disclosures of which are incorporated herein by reference.

### TECHNICAL FIELD

The present invention generally relates to a nonwoven fabric, and specifically to an engineered nonwoven fabric imparted with a discontinuous, irregular, three-dimensional pattern, which results in a sufficiently resilient material that exhibits a uniform multi-directional cleaning performance imminently suitable for numerous applications including the treatment, cleaning and/or cleansing of surfaces.

### BACKGROUND OF THE INVENTION

The general use of nonwoven fabrics as a component in cleaning and/or cleansing articles is well known in the art. Various cleaning products, and specifically personal hygiene, baby and hard surface cleaning sheets, are commercially available which utilize one or more layers of nonwoven fabrics in the construction of said cleaning sheet. Substantially, these cleaning sheets are two-dimensional or planar in construction. As the surface topography of such two-dimensional cleaning sheet is inherently restricted by the composition of the cleaning sheet, frictional cleaning induced by the composition is limited, thus necessitating increased consumption of said wipe to effect satisfactory levels of cleanliness or other treatment of the surface.

Attempts have been made to induce three-dimensionality into the conventional cleaning sheet in order to improve the cleaning performance; however the induction of three-dimensional patterns and/or images into conventional cleaning sheets can prove to have an overall deleterious affect on the cleaning performance of the sheet. Patterns or images that protrude from the background of the cleaning sheet tend to be continuous or repetitive, having a similar height and width in which the image or pattern extends into the foreground of the cleaning sheet. The repetitive imaged or patterned foreground ultimately comes into direct contact with the surface to be cleaned. Depending on the direction the cleaning sheet travels along the soiled surface, a corresponding pattern of unaffected particulates reflecting the un-imaged or un-patterned surface of the cleaning sheet is left behind on the surface.

A need remains for a cleaning sheet imparted with a three-dimensional image and/or pattern that can travel about any direction of a soiled surface capturing all particulates within the path of the cleaning sheet.

### SUMMARY OF THE INVENTION

The present invention is directed to a nonwoven fabric, and specifically to an engineered nonwoven fabric imparted with a discontinuous, irregular, three-dimensional pattern, which results in a sufficiently resilient material that exhibits a uniform multi-directional cleaning performance imminently suitable for numerous applications including the treatment, cleaning and/or cleansing of surfaces.

In accordance with the present invention, nonwoven fabrics are formed, comprising a three-dimensional pattern that includes a combination of background elements, which can be described as “crannies” or depressions of varying size and scale, with projection or extension elements, which can be described as raised ridges that protrude out of, or way from, the background elements. Further, the background elements and projection elements are of a discontinuous, irregular pattern, whereby the three-dimensional pattern lacks linearity, order, or organization. The irregularity attributed to the three-dimensional pattern is especially suited for cleaning sheets. The “crannies” and ridges of the aforementioned cleaning sheet act to entrap and entrain topically applied or impregnated additives, providing the cleaning sheet with an improved carrying capacity for various aqueous or non-aqueous cleaning and cleansing solutions.

Cleaning sheets incorporating the three-dimensional, discontinuous, irregular pattern of “crannies” and raised ridges facilitates the cleaning process through continuous pick-up of particulates that may otherwise be left behind by a cleaning sheet comprised of a linear, regular three-dimensional pattern. In addition, the cleaning sheet has a multi-directional cleaning performance, whereby the cleaning sheet may travel about a soil surface in any direction without leaving behind a streak or a trail of unaffected particulates.

An exemplary manufacturing technology suitable for forming nonwoven fabrics in accordance with the present invention comprises the steps of providing a precursor fibrous web that is subjected to hydraulic energy. By this hydroentanglement method, a fibrous batt is formed and integrated into a three-dimensional nonwoven fabric by application of hydraulic energy on a three-dimensional image transfer device. The image transfer device defines three-dimensional asperities against which the precursor web is forced during hydroentanglement process, whereby the fibrous constituents of the web are simultaneously imparted with a given combination of background elements, projection elements and optionally, a plurality of orifices, by movement of the fibrous into regions upon and between the three-dimensional asperities of the transfer device.

Subsequent to hydroentanglement, the three-dimensionally imaged cleaning sheets may be subjected to one or more variety of post-entanglement performance modifying treatments. Such treatments may include application of a polymeric binder composition, mechanical compacting, application of surfactant or electrostatic compositions, printing or dyeing, and like processes.

Subsequent to three-dimensional imaging, the imaged nonwoven cleaning sheet may be treated with one or more performance or aesthetic modifying composition to further alter the fabric structure or to meet end-use article requirements. A polymeric binder composition can be selected to enhance durability characteristics of the fabric, while maintaining the desired softness and drapeability of the three-dimensionally imaged fabric. A surfactant can be applied so as to impart hydrophilic properties. In addition, electrostatic modifying compound can be used to aid in cleaning or dusting applications.

Other features and advantages of the present invention will become readily apparent from the following detailed description, the accompanying drawings, and the appended claims.

### BRIEF DESCRIPTION OF THE DRAWINGS

The invention will be more easily understood by a detailed explanation of the invention including drawings. Accordingly, drawings which are particularly suited for explaining the invention are attached herewith; however, is should be understood that such drawings are for explanation purposes only and are not necessarily to scale. The drawings are briefly described as follows:

FIG. 1 is a diagrammatic view of a representative device suitable for the manufacture of the nonwovens in accordance with the present invention;

FIG. 2 is a photomicrograph of the nonwoven fabric of the present invention; and

FIG. 3 is a photomicrograph of the reverse side of the nonwoven fabric in FIG. 2.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

Nonwoven fabrics are used in a wide variety of applications, including home care, medical, hygiene, and industrial, whereby the engineered qualities of the fabric can be advantageously employed. These types of fabrics differ from traditional woven or knitted fabrics in that the fabrics are produced directly from a fibrous mat, eliminating the traditional textile manufacturing processes of multi-step yarn preparation, and weaving or knitting. Integration of the fibers or filaments of the fabric acts to provide the fabric with a useful level of integrity. Subsequent to integration, the fabric can be further enhanced by the application of binder compositions and/or by thermal stabilization of the entangled fibrous matrix.

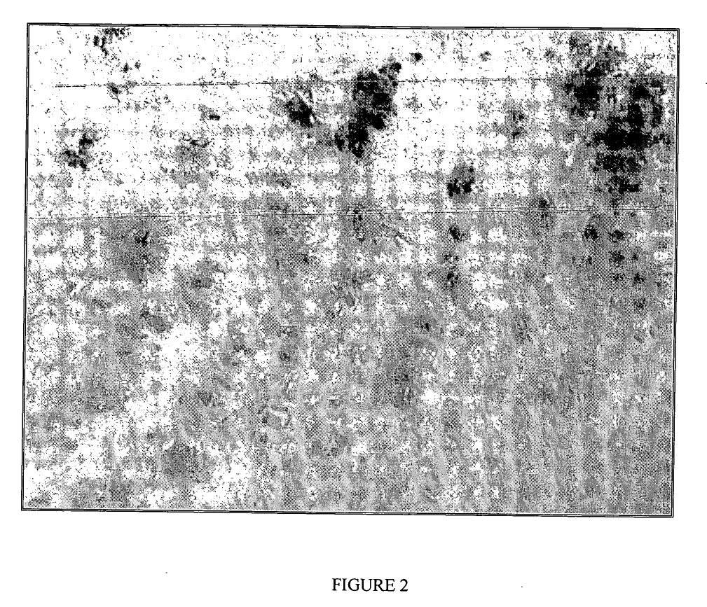

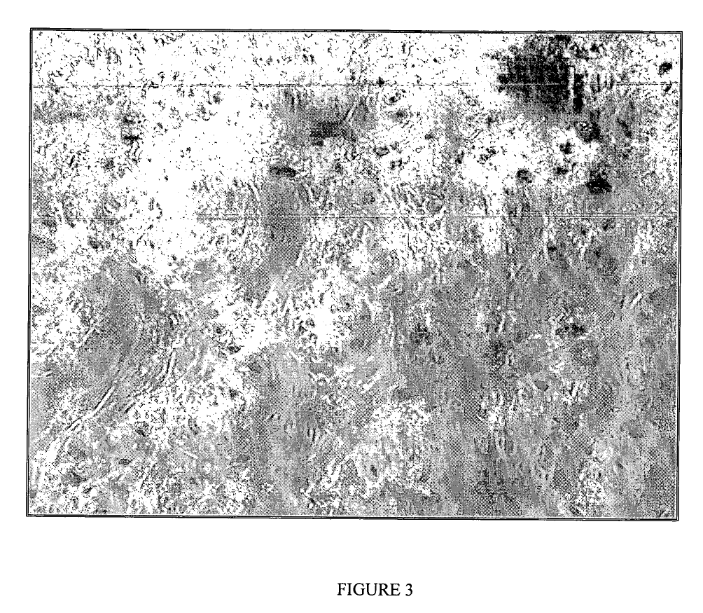

In accordance with the present invention, a nonwoven cleaning sheet is formed, comprising a discontinuous, irregular, three-dimensional pattern, which results in a sufficiently resilient material that exhibits a uniform multi-directional cleaning performance imminently suitable for numerous applications including the treatment, cleaning and/or cleansing of surfaces. The discontinuous, irregular, three-dimensional pattern includes a combination of background elements, which can be described as crannies or depressions of varying size and scale, with projection or extension elements, which can be described as ridges that protrude out of, or way from, the background elements. Further, the background elements and projection elements are of a discontinuous, irregular pattern, three-dimensional pattern lacking linearity or order. FIG. 2 is a photomicrograph representative of the three-dimensional nonwoven fabric of the present invention. FIG. 3 is a photomicrograph illustrating the reverse side of that shown in FIG. 2.

Manufacture of a cleaning sheet embodying the principles of the present invention is initiated by providing a batt or layer of fibrous components. The fibrous batt can be comprised of finite-length staple fibers or essentially continuous filaments selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for use include polyolefins, polyamides and polyesters. The thermoplastic polymers may be further selected from homopolymers; copolymers, conjugates and other derivatives including those thermoplastic polymers having incorporated melt additives or surface-active agents. Staple lengths are selected in the range of 0.25 inch to 8 inches, the range of 1 to 3 inches being preferred and the fiber denier selected in the range of 1 to 15, the range of 2 to 6 denier being preferred for general applications. The profile of the fiber is not a limitation to the applicability of the present invention.

It is within the purview of the present invention that a scrim can be incorporated in the formation of the resulting cleaning sheet. The purpose of the scrim is to reduce the extensibility of the resultant three-dimensional imaged nonwoven fabric, thus reducing the possibility of three-dimensional image distortion and further enhancing fabric durability. Suitable scrims include unidirectional monofilaments, bi-directional monofilaments, expanded or apertured films, thermoplastic continuous filament nonwoven fabrics (i.e. spunbond), and the blends thereof.

It is also within the purview of the present invention that a binder material can be either incorporated as a fusible component fiber in the formation of the precursor nonwoven web or as a liquid adhesive applied after nonwoven fabric formation to one face or both faces of the fabric. The binder material will further improve the durability or otherwise provide enhanced cleaning performance of the resultant imaged cleaning sheet during use. For instance, incorporated binders may provide an additional scrubbing or exfoliating performance to the cleaning sheet, rendering it suitable for the gentle removal of dead skin or the removal of particulates stuck-on hard surfaces.

An exemplary manufacturing technology comprises the steps of providing a precursor fibrous batt that is subjected to simultaneous mechanical displacement and integration by means of hydraulic energy. U.S. Pat. No. 3,485,706, to Evans, hereby incorporated by reference, discloses processes for effecting hydroentanglement of nonwoven fabrics. More recently, hydroentanglement techniques have been developed which impart images or patterns to the entangled fabric by effecting hydroentanglement on three-dimensional image transfer devices. Such three-dimensional image transfer devices are disclosed in U.S. Pat. No. 5,098,764, hereby incorporated by reference, with the use of such image transfer devices being desirable for providing a fabric with enhanced physical properties as well as having a pleasing appearance.

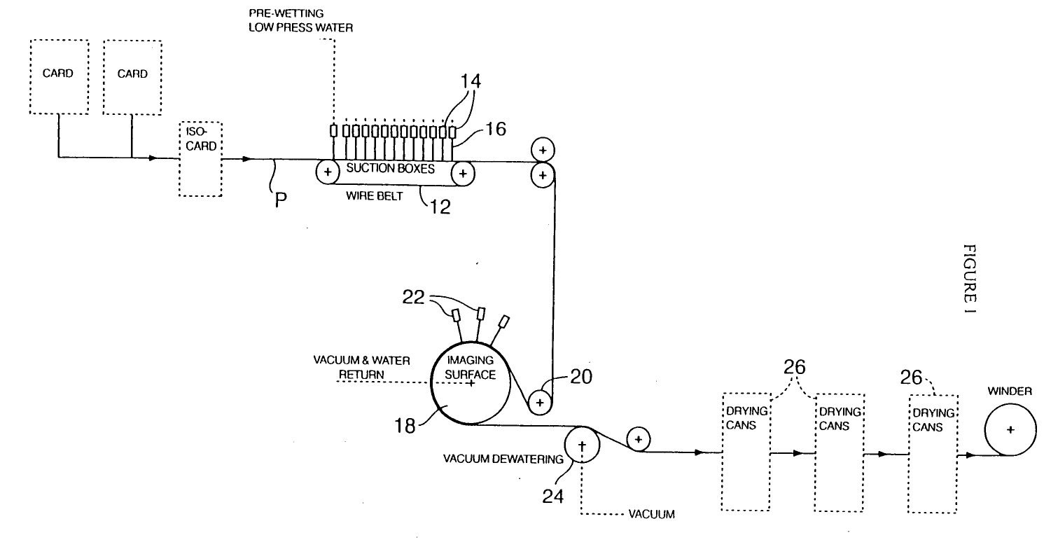

With reference to FIG. 1, therein is illustrated an apparatus for practicing the present method for forming a nonwoven cleaning sheet. The sheet is formed from a fibrous matrix, which typically comprises staple length fibers, but may comprise substantially continuous filaments. The fibrous matrix is preferably carded and cross-lapped to form a fibrous batt, designated F. In a current embodiment, the fibrous batt comprises 100% cross-lap fibers, that is, all of the fibers of the web have been formed by cross-lapping a carded web so that the fibers are oriented at an angle relative to the machine direction of the resultant web. U.S. Pat. No. 5,475,903, hereby incorporated by reference, illustrates a web drafting apparatus.

The apparatus of the present invention includes a foraminous forming surface in the form of a flat bed entangler 12 upon which the precursor web P is positioned for pre-entangling. Precursor web P is then sequentially passed under entangling manifolds 14, whereby the precursor web is subjected to high-pressure water jets 16.

The entangling apparatus of FIG. 1 further includes an imaging and patterning drum 18 comprising a three-dimensional image transfer device for effecting imaging and patterning of the now-entangled precursor web. After pre-entangling, the precursor web is trained over a guide roller 20 and directed to the image transfer device 18, where a plurality of three-dimensional images are imparted into the fabric on the foraminous forming surface of the device. The web of fibers is juxtaposed to the image transfer device 18, and high pressure water from manifolds 22 is directed against the outwardly facing surface from jet spaced radially outwardly of the image transfer device 18. The image transfer device 18, and manifolds 22, may be formed and operated in accordance with the teachings of commonly assigned U.S. Pat. No. 5,098,764, No. 5,244,711, No. 5,822,823, and No. 5,827,597, the disclosures of which are hereby incorporated by reference. The entangled fabric can be vacuum dewatered at 24, and dried at an elevated temperature on drying cans 26.

In accordance with the present invention, the nonwoven cleaning sheet may include the use of various aqueous and non-aqueous compositions. The three-dimensional discontinuous, irregular image or pattern imparted into the structure of the nonwoven fabric results in a cleaning sheet material that exhibits a combination of background elements, which can be described as depressions or “crannies” of varying size and scale, with projection or extension elements, or raised ridges that protrude out of, or way from, the background elements. The “crannies” and ridges of the aforementioned cleaning sheet act to entrap and entrain topically applied or impregnated additives, providing the cleaning sheet with an improved carrying capacity for various cleaning and cleansing solutions.

The discontinuous, irregular three-dimensional pattern of the present cleaning sheet is characterized by a non-linear pattern, i.e., an absence of linear elements, as well as by an absence of defined arcuate shapes and surfaces. While irregular, however, the pattern exhibits upstanding elements which, within a sufficiently large defined surface of the sheet, are of substantially the same cumulative surface area as the upstanding elements within another, similarly-dimensioned surface area of the sheet.

The cleaning sheet embodying the principles of the present invention is especially suitable for home care cleaning or cleansing articles. The nonwoven sheet may be used in various home care applications, wherein the end use article may be a dry or wet hand held sheet, such as a wipe, a mitt formation, or a cleaning implement capable of retaining the cleaning sheet. The various end uses suitable for cleaning household surfaces such as, kitchen and bathroom countertops, sinks, bathtubs, showers, appliances, and fixtures.

Cleansing compositions suitable for such end use applications include those that are described in U.S. Pat. No. 6,103,683 to Romano, et al., U.S. Pat. No. 6,340,663 to Deleo, et al., U.S. Pat. No. 5,108,642 to Aszman, et al., and U.S. Pat. No. 6,534,472 Arvanitidou, et al., all of which are hereby incorporated by reference. Selected cleaning compositions may also include surfactants, such as alkylpolysaccharides, alkyl ethoxylates, alkyl sulfonates, and mixtures thereof; organic solvent, mono- or polycarboxylic acids, odor control agents, such as cyclodextrin, peroxides, such as benzoyl peroxide, hydrogen peroxide, and mixtures thereof, thickening polymers, aqueous solvent systems, suds suppressors, perfumes or fragrances, and detergent adjuvants, such as detergency builder, buffer, preservative, antibacterial agent, colorant, bleaching agents, chelants, enzymes, hydrotropes, and mixtures thereof. The aforementioned compositions preferably comprise from about 50% to about 500%, preferably from about 200% to about 400% by weight of the nonwoven cleaning sheet.

The cleaning sheet embodying the principles of the present invention is also suitable for personal cleaning or cleansing articles. Non-limiting examples of such applications include dry or wet facial wipes, body wipes, and baby wipes. Suitable methods for the application of various aqueous and non-aqueous compositions comprise aqueous/alcoholic impregnates, including flood coating, spray coating or metered dosing. Further, more specialized techniques, such as Meyer Rod, floating knife or doctor blade, which are typically used to impregnate cleansing solutions into absorbent sheets, may also be used. The following compositions preferably comprise from about 50% to about 500%, preferably from about 200% to about 400% by weight of the nonwoven cleaning sheet.

The nonwoven laminate incorporates a functional additive, such as an alpha-hydroxycarboxylic acid, which refers not only the acid form but also salts thereof. Typical cationic counterions to form the salt are the alkali metals, alkaline earth metals, ammonium, C₂-C₈ trialkanolammonium cation and mixtures thereof. The term “alpha-hydroxycarboxylic acids” include not only hydroxyacids but also alpha-ketoacids and related compounds of polymeric forms of hydroxyacid.

Amounts of the alpha-hydroxycarboxylic acids may range from about 0.01 to about 20%, preferably from about 0.1 to about 15%, more preferably from about 1 to about 10%, optimally from about 3 to about 8% by weight of the composition which impregnates the substrate. The amount of impregnating composition relative to the substrate may range from about 20:1 to 1:20, preferably from 10:1 to about 1:10 and optimally from about 2:1 to about 1:2 by weight.

Further, a humectant may be incorporated with the aforementioned alpha-hydroxycarboxylic compositions. Humectants are normally polyols. Representative polyols include glycerin, diglycerin, polyalkylene glycols and more preferably alkylene polyols and their derivatives. Amounts of the polyol may range from about 0.5 to about 95%, preferably from about 1 to about 50%, more preferably from about 1.5 to 20%, optimally from about 3 to about 10% by weight of the impregnating composition.

A variety of cosmetically acceptable carrier vehicles may be employed although the carrier vehicle normally will be water. Amounts of the carrier vehicle may range from about 0.5 to about 99%, preferably from about 1 to about 80%, more preferably from about 50 to about 70%, optimally from about 65 to 75% by weight of the impregnating composition.

Preservatives can desirably be incorporated protect against the growth of potentially harmful microorganisms. Suitable traditional preservatives for compositions of this invention are alkyl esters of para-hydroxybenzoic acid. Other preservatives which have more recently come into use include hydantoin derivatives, propionate salts, and a variety of quaternary ammonium compounds. Preservatives are preferably employed in amounts ranging from 0.01% to 2% by weight of the composition.

The cosmetic composition may further include herbal extracts. Illustrative extracts include Roman Chamomile, Green Tea, Scullcap, Nettle Root, Swertia laponica, Fennel and Aloe Vera extracts. Amount of each of the extracts may range from about 0.001 to about 1%, preferably from about 0.01 to about 0.5%, optimally from about 0.05 to about 0.2% by weight of a composition.

Additional functional cosmetic additives may also include vitamins such as Vitamin E Acetate, Vitamin C, Vitamin A Palmitate, Panthenol and any of the Vitamin B complexes. Anti-irritant agents may also be present including those of steviosides, alpha-bisabolol and glycyhrizzinate salts, each vitamin or anti-irritant agent being present in amounts ranging from about 0.001 to about 1.0%, preferably from about 0.01 to about 0.3% by weight of the composition.

These impregnating compositions of the present invention may involve a range of pH although it is preferred to have a relatively low pH, for instance, a pH from about 2 to about 6.5, preferably from about 2.5 to about 4.5.

In addition to cosmetic compositions, lotions may be incorporated into the nonwoven cleaning sheet. The lotion preferably also comprises one or more of the following: an effective amount of a preservative, an effective amount of a humectant, an effective amount of an emollient; an effective amount of a fragrance, and an effective amount of a fragrance solubilizer.

As used herein, an emollient is a material that softens, soothes, supples, coats, lubricates, or moisturizes the skin. The term emollient includes, but is not limited to, conventional lipid materials (e.g. fats, waxes), polar lipids (lipids that have been hydrophylically modified to render them more water soluble), silicones, hydrocarbons, and other solvent materials. Emollients useful in the present invention can be petroleum based, fatty acid ester type, alkyl ethoxylate type, fatty acid ester ethoxylates, fatty alcohol type, polysiloxane type, mucopolysaccharides, or mixtures thereof.

Humectants are hygroscopic materials that function to draw water into the stratum comeum to hydrate the skin. The water may come from the dermis or from the atmosphere. Examples of humectants include glycerin, propylene glycol, and phospholipids.

Fragrance components, such as perfumes, include, but are not limited to water insoluble oils, including essential oils. Fragrance solubilizers are components which reduce the tendency of the water insoluble fragrance component to precipitate from the lotion. Examples of fragrance solubilizers include alcohols such as ethanol, isopropanol, benzyl alcohol, and phenoxyethanol; any high HLB (HLB greater than 13) emulsifier, including but not limited to polysorbate; and highly ethoxylated acids and alcohols.

Preservatives prevent the growth of micro-organisms in the liquid lotion and/or the substrate. Generally, such preservatives are hydrophobic or hydrophilic organic molecules. Suitable preservatives include, but are not limited to parabens, such as methyl parabens, propyl parabens, and combinations thereof.

The lotion can also comprise an effective amount of a kerotolytic for providing the function of encouraging healing of the skin. An especially preferred kerotolytic is Allantoin ((2,5-Dioxo-4-Imidazolidinyl)Urea), a heterocyclic organic compound having an empirical formula C₄H₆N₄O₃. Allantoin is commercially available from Tri-K Industries of Emerson, N.J. It is generally known that hyperhydrated skin is more susceptible to skin disorders, including heat rash, abrasion, pressure marks and skin barrier loss. A premoistened wipe according to the present invention can include an effective amount of allantoin for encouraging the healing of skin, such as skin which is over hydrated.

U.S. Pat. No. 5,534,265 issued Jul. 9, 1996; U.S. Pat. No. 5,043,155 issued Aug. 27, 1991; and U.S. Pat. No. 5,648,083 issued Jul. 15, 1997 are incorporated herein by reference for the purpose of disclosing additional lotion ingredients.

The lotion can further comprise between about 0.1 and about 3 percent by eight Allantoin, and about 0.1 to about 10 percent by weight of an aloe extract, such as aloe Vera, which can serve as an emollient. Aloe vera extract is available in the form of a concentrated powder from the Rita Corporation of Woodstock, Ill.

Further, latherants may be incorporated within the cleaning sheet. Non-limiting examples of anionic lathering surfactants useful in the compositions of the present invention are disclosed in McCutcheon's, Detergents and Emulsifiers, North American edition (1986), published by allured Publishing Corporation; McCutcheon's, Functional Materials, North American Edition (1992); and U.S. Pat. No. 3,929,678, to Laughlin et al., issued Dec. 30, 1975, all of which are incorporated by reference herein in their entirety. A wide variety of anionic lathering surfactants are useful herein. Non-limiting examples of anionic lathering surfactants include those selected from the group consisting of sarcosinates, sulfates, isethionates, taurates, phosphates, lactylates, glutamates, and mixtures thereof.

Non-limiting examples of nonionic lathering surfactants and amphoteric surfactants for use in the compositions of the present invention are disclosed in McCutcheon's, Detergents and Emulsifiers, North American edition (1986), published by allured Publishing Corporation; and McCutcheon's, Functional Materials, North American Edition (1992); both of which are incorporated by reference herein in their entirety.

Nonionic lathering surfactants useful herein include those selected from the group consisting of alkyl glucosides, alkyl polyglucosides, polyhydroxy fatty acid amides, alkoxylated fatty acid esters, lathering sucrose esters, amine oxides, and mixtures thereof.

The term “amphoteric lathering surfactant,” as used herein, is also intended to encompass zwitterionic surfactants, which are well known to formulators skilled in the art as a subset of amphoteric surfactants.

A wide variety of amphoteric lathering surfactants can be used in the compositions of the present invention. Particularly useful are those which are broadly described as derivatives of aliphatic secondary and tertiary amines, preferably wherein the nitrogen is in a cationic state, in which the aliphatic radicals can be straight or branched chain and wherein one of the radicals contains an ionizable water solubilizing group, e.g., carboxy, sulfonate, sulfate, phosphate, or phosphonate. Non-limiting examples of amphoteric or zwitterionic surfactants are those selected from the group consisting of betaines, sultaines, hydroxysultaines, alkyliminoacetates, iminodialkanoates, aminoalkanoates, and mixtures thereof.

Additional compositions utilized in accordance with the present invention can comprise a wide range of optional ingredients. The CTFA International Cosmetic ingredient Dictionary, Sixth Edition, 1995, which is incorporated by reference herein in its entirety, describes a wide variety of non-limiting cosmetic and pharmaceutical ingredients commonly used in the skin care industry, which are suitable for use in the compositions of the present invention. Non-limiting examples of functional classes of ingredients are described at page 537 of this reference. Examples of these functional classes include: abrasives, anti-acne agents, anticaking agents, antioxidants, binders, biological additives, bulking agents, chelating agents, chemical additives, natural additives, colorants, cosmetic astringents, cosmetic biocides, degreasers, denaturants, drug astringents, emulsifiers, external analgesics, film formers, fragrance components, humectants, opacifying agents, plasticizers, preservatives, propellants, reducing agents, skin bleaching agents, skin-conditioning agents (emollient, humectants, miscellaneous, and occlusive), skin protectants, solvents, foam boosters, hydrotropes, solubilizing agents, suspending agents (nonsurfactant), sunscreen agents, ultraviolet light absorbers, and viscosity increasing agents (aqueous and nonaqueous). Examples of other functional classes of materials useful herein that are well known to one of ordinary skill in the art include solubilizing agents, sequestrants, and keratolytics, and the like.

The aforementioned classes of ingredients are incorporated in a safe and effective amount. The term “safe and effective amount” as used herein, means an amount of an active ingredient high enough to modify the condition to be treated or to deliver the desired skin benefit, but low enough to avoid serious side effects, at a reasonable benefit to risk ratio within the scope of sound medical judgment.

In addition to home care and personal care end uses, the nonwoven cleaning sheet may be used in industrial and medical applications. For instance, the cleaning sheet may be useful in paint preparation and cleaning outdoor surfaces, such as lawn furniture, grills, and outdoor equipment, wherein the low Tinting attributes of the laminate may be desirable. Aqueous or non-aqueous functional industrial solvents include, oils, such as plant oils, animal oils, terpenoids, silicon oils, mineral oils, white mineral oils, paraffinic solvents, polybutylenes, polyisobutylenes, polyalphaolefins, and mixtures thereof, toluenes, sequestering agents, corrosion inhibitors, abrasives, petroleum distillates, and the combinations thereof.

A medical cleaning sheet may incorporate an antimicrobial composition, including, but not limited to iodines, alcohols, such as such as ethanol or propanol, biocides, abrasives, metallic materials, such as metal oxide, metal salt, metal complex, metal alloy or mixtures thereof, bacteriostatic complexes, bactericidal complexes, and the combinations thereof.

The cleaning sheet of the present invention is particularly suitable for dispensing from a tub of stacked, folded wipes, or for dispensing as “pop-up” wipes, in which the cleaning sheet is stored in the tub as a perforated continuous roll, wherein upon pulling a wipe out of the tub, an edge of the next wipe is presented for easy dispensing. The wipes of the present invention can be folded in any of various known folding patterns, such as C-folding, but is preferably Z-folded. A Z-folded configuration enables a folded stack of wipes to be interleaved with overlapping portions. The cleaning sheet may be packaged in various convenient forms, whereby the method of packaging is not meant to be a limitation of the present invention.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

1. A cleaning sheet having a uniform multi-directional cleaning performance comprising a nonwoven fabric imaged by hydroentanglement on a three-dimensional image transfer device, wherein said image exhibits a discontinuous, irregular three-dimensional pattern.

2. (canceled)

3. A cleaning sheet as in claim 1, wherein said imaged nonwoven fabric is a medical cleaning sheet.

4. A cleaning sheet as in claim 1, wherein said imaged nonwoven fabric is an industrial cleaning sheet.

5. A cleaning sheet as in claim 1, wherein said imaged nonwoven fabric is a hygienic cleaning sheet.

6. A cleaning sheet as in claim 1, wherein said imaged nonwoven fabric is a home care cleaning sheet.

7. A cleaning sheet as in claim 1, wherein said discontinuous, irregular three-dimensional pattern is characterized by a non-linear pattern, and by an absence of defined arcuate shapes and surfaces.

8. A cleaning sheet as in claim 1, including a cleaning composition comprising an effective amount of a cleaning surfactant, said cleansing composition being coated onto or impregnated into said nonwoven fabric to the extent of from 50% to 500% by weight of said fabric.

9. A cleaning sheet as in claim 1, wherein said nonwoven fabric is formed from carded, cross-lapped staple length fibers.

10. A cleaning sheet as in claim 1, wherein said nonwoven fabric comprises a scrim in the form of a nonwoven spunbond fabric.

11. A cleaning sheet having a uniform multi-directional cleaning performance comprising a nonwoven fabric imaged by hydroentanglement on a three-dimensional image transfer device, wherein said image exhibits a discontinuous, irregular three-dimensional pattern, characterized by a non-linear pattern and an absence of defined arcuate shapes and surfaces, said nonwoven fabric being formed from carded, cross-lapped staple length fibers, and comprising a scrim in the form of a nonwoven spunbond fabric.

12. A cleaning sheet as in claim 1, including a cleaning composition comprising an effective amount of a cleaning surfactant, said cleansing composition being coated onto or impregnated into said nonwoven fabric to the extent of from 50% to 500% by weight of said fabric.

13. A method of forming a cleaning sheet having multi-directional cleaning performance, comprising the steps of:
providing a three-dimensional image transfer device having an imaging surface exhibiting a discontinuous, irregular three-dimensional image;
providing a fibrous matrix comprising carded and cross-lapped staple length fibers, and
positioning said fibrous matrix on said three-dimensional image transfer device, and hydroentangling said fibrous matrix to form a nonwoven fabric exhibiting said discontinuous, irregular three-dimensional image.

14. A method of forming a cleaning sheet as in claim 14, wherein
the discontinuous, three-dimensional image is characterized by a non-linear pattern and by an absence of defined arcuate shapes and surfaces.

15. A method of forming a cleaning sheet as in claim 13, including a cleaning composition comprising an effective amount of a cleaning surfactant, said cleansing composition being coated onto or impregnated into said nonwoven fabric to the extent of from 50% to 500% by weight of said fabric.
